(19) United States
(12) Patent Application Publication
(10) Pub. No.: US 2005/0123304 A1
(43) Pub. Date: Jun. 9, 2005

(54) Optical transmission system for transmitting optical signals having different transmission rates

(75) Inventors: Gottfried Lehmann, Petershausen (DE); Eckhard Meissner, Zorneding (DE)

Correspondence Address: Siemens Corporation;Intellectual Property Department, 170 Wood Avenue South, Iselin, NJ, 08830, US

(73) Assignee: Siemens Aktiengesellschaft, Munchen (DE)

(21) Appl. No.: 10/500,746

(22) PCT Filed: Jul. 7, 2003
(86) PCT No.: PCT/DE03/02270

(30) Foreign Application Priority Data
Jul. 31, 2002 (DE) 102 34 918.5

(51) Int. Cl. H04B 10/12

(52) U.S. Cl. 398/147

(57) ABSTRACT

The invention relates to an optical transmission system for transmitting optical signals consisting of N lengths of optical fibre, each comprising an optical fibre and a dispersion compensation unit. In order to transmit first optical signals having a first data transmission rate, the compensating amounts of the first to N-th dispersion compensation units are dimensioned in such a way that the first to N-th lengths of fibre are respectively under compensated by approximately the same undercompensating amount. In order to then transmit second optical signals having a second data transmission rate, a pre-compensation unit for pre-compensating the second optical signals is mounted upstream of the first length of fibre, said pre-compensation unit having a pre-compensating amount of between 0 ps/nm and −2000 ps/nm. In this way, optical signals having a higher bit rate, especially 40 Gbit/s-signals, can then be transmitted by means of an optical transmission system which is optimised in terms of dispersion for optical signals having a lower bit rate, especially 10 Gbit/s-signals.

### CROSS REFERENCE TO RELATED APPLICATIONS

This application is the US National Stage of International Application No. PCT/DE2003/002270, filed Jul. 7, 2003 and claims the benefit thereof. The International Application claims the benefits of German Patent application No. 10234918.5 DE filed Jul. 31, 2002, both of the applications are incorporated by reference herein in their entirety.

### FIELD OF INVENTION

The invention relates to an optical transmission system for transmitting optical signals consisting of N lengths of optical fiber, each comprising an optical fiber and a dispersion compensation unit, in which in order to transmit first optical signals having a first data transmission rate, the compensating amounts of the first to N-th dispersion compensation units are dimensioned in such a way that the first to N-th lengths of fiber are respectively under-compensated by approximately the same under-compensation amount.

### BACKGROUND OF INVENTION

In optical transmission systems with high data transmission rates, such as optical transmission systems operating on the WDM principle (wavelength division multiplexing), the chromatic dispersion which occurs in the fiber during the transmission of optical signals, and other non-linear effects such as self modulation (SPM) or cross-phase modulation (EXPM), cause distortions in the optical signals being transmitted. Such distortions in the optical signals being transmitted are among other things dependent on the optical launch power of the optical signal, the data transmission rate and the type of fiber being used for the purpose of transmission. The regeneration-free, bridgeable transmission range of an optical transmission system is restricted by the distortions resulting from the chromatic dispersion in the fiber and the non-linear effects. In this context the expression regeneration-free, bridgeable transmission range means the range over which an optical data signal can be transmitted without the need to carry out a regeneration or “3R regeneration” (electronic data regeneration affecting the amplitude, edge and clock pulse of an optically transmitted digital data signal). The regeneration-free, bridgeable transmission range is therefore defined by the signal-to-noise ratio required for the reconstruction of the data in an optical signal at the end of a length of optical fiber.

In order to compensate optical data signals, suitable dispersion compensation units are provided, for instance during transmission of optical signals via standard optical single mode fibers, and/or dispersion management adapted to the optical transmission line is operated for the same purpose. Dispersion management means a purposeful arrangement of dispersion compensation units along the optical transmission line, for instance optical transmitters, intermediate optical amplifiers and/or optical receivers, together with determination of the appropriate dispersion compensating amounts of the dispersion compensation units.

Optical transmission systems consist of a plurality of lengths of optical fiber in which the dispersion arising within the fibers in the lengths of optical fiber concerned is virtually completely compensated with the aid of at least one dispersion compensation unit or in some cases over-compensated or under-compensated by a defined amount.

Such dispersion compensation units may be designed in the form of special optical fibers in which a special choice of the refractive index profile in the fiber core and in the surrounding sheath layers of the optical fibers ensures that the dispersion or fiber dispersion, particularly in the transmission wavelength range, takes on highly negative values. The dispersion amounts caused by optical transmission fibers, such as standard single mode fibers, can be effectively compensated with the aid of the highly negative dispersion values caused by the dispersion compensating fibers. From the eye-opening needed for reconstruction of the optical signal at the. end of the length of optical fiber and/or the signal-to-noise ratio needed for this purpose, it is possible to calculate the maximum regeneration-free, bridgeable transmission range and/or the maximum number N of lengths of optical fiber.

Previous embodiments of optical transmission systems have used different dispersion management schemes in which the optimum dispersion compensation for an optical transmission line can be achieved by using lengths of optical fiber that may be pre-compensated and/or post-compensated, or may be differently over-compensated or under-compensated. Depending in each case on the data transmission rate, the data format and the fiber characteristics, a spatially defined distance can be bridged using a defined number of lengths of optical fiber.

From German disclosure document 19945143 there is known to be a dispersion management scheme for an optical transmission system in which optical signals with data transmission rates of around 10 Gbit/s are transmitted via a defined number of lengths of optical fiber. To increase the regeneration-free, bridgeable transmission range of the optical transmission system, the compensation amounts of the dispersion compensation units at the end of each length of optical fiber are dimensioned in such a way that the accumulated residual dispersion per length of optical fiber increases at least approximately equally by the same dispersion amount in each case, that is, the accumulated residual dispersion calculated or estimated for the total optical transmission system is distributed approximately equally over the lengths of optical fiber and thus each length of optical fiber is under-compensated by approximately the same compensation amount.

Moreover from German patent application 10127345 there is known to be a dispersion management scheme for an optical transmission system in which optical signals with increased data transmission rates of over 40 Gbit/s are transmitted via a defined number of lengths of optical fiber. In this case to increase the regeneration-free, bridgeable transmission range of the optical transmission system, the compensation amounts of the dispersion compensation units at the end of each length of optical fiber are dimensioned in such a way that the first to N-th lengths of fiber are respectively over-compensated by approximately the same over-compensating amount. Furthermore the over-compensation amount of the N-th dispersion compensation unit is dimensioned in such a way that the accumulated fiber dispersion at the output from the optical transmission system is virtually completely compensated.

When optical signals are being transmitted at two different data transmission rates, for instance 10 Gbit/s and 40 Gbit/s signals, each in a WDM channel via an optical transmission system optimized for transmitting a first lower data transmission rate, the optical signals having a second higher data transmission rate become so distorted that reconstruction of these optical data signals at the end of the section is not possible.

### SUMMARY OF INVENTION

The object of the present invention is to specify an optical transmission system capable of transmitting optical signals at a high bit rate and having dispersion compensation units that are dimensioned in such a way that it is possible to transmit at least two optical signals having different data transmission rates. This object is achieved by virtue of the features specified in the pre-characterizing clause of claim 1 in relation to its characterizing features.

The important aspect of the invention is the fact that in order to transmit second optical signals having a second data transmission rate, a pre-compensation unit for pre-compensating the second optical signals is mounted upstream of the first length of fiber, said pre-compensation unit having a pre-compensating amount of between 0 ps/nm and −2000 ps/nm. In this way, by means of an existing optical transmission system optimized in terms of dispersion for the transmission of first optical signals having a first optical transmission rate, such as 10 Gbit/s, it is also possible to transmit second optical signals having a second data transmission rate, such as 40 Gbit/s. Without the pre-compensation amount to which the invention relates in the range between 0 ps/nm and −2000 ps/nm, the non-linear effects of the self phase modulation cause distortion of the optical 40 Gbit/s signal during transmission, leading to a considerable diminution of the regeneration-free, bridgeable transmission range. This distortion is significantly reduced by the pre-compensation to which the invention relates, so that both during the transmission of 10 Gbit/s signals and during the transmission of 40 Gbit/s signals the optical transmission system exhibits for the respective transmission rate nearly the same transmission characteristics as a transmission system optimized in terms of dispersion for the respective transmission rate.

A further advantageous aspect of the invention lies in the fact that the optical transmission system has a pre-compensation amount which is dependent on the size of the launch power of the second optical signal having a second data transmission rate, and on the type of fiber used for transmission, the optical fiber being produced in the form of a standard single mode fiber or a non-zero dispersion-shifted fiber.

According to another embodiment of the invention the second data transmission rate is at least double the first data transmission rate. For this reason according to the invention different pre-compensation amounts are advantageous for different fiber types. For example for a standard single mode fiber the pre-compensation amount for an optical signal with a data transmission rate of 40 Gbit/s and a non-return-to-zero data format is defined to a close approximation by the following relation:
D_{PC}=(−11+1.665·P_{launch}/[dBm])·Dᵢₙₗᵢₙₑ−270[ps/nm]
where

P_{launch}=launch power of the optical signal having the second data transmission rate, per length of optical fiber, and

Dᵢₙₗᵢₙₑ=average under-compensation amount of the first to N-th dispersion compensation units.

In comparison, for the use of a non-zero dispersion-shifted fiber (NZDSF) in the case of an optical signal with a data transmission rate of 40 Gbit/s and a non-return-to-zero data format, the resulting relation is approximately as follows:
D_{PC}=(−12.5+1.2·P_{launch}/[dBm])·Dᵢₙₗᵢₙₑ−25[ps/nm]
where likewise

P_{launch}=launch power of the optical signal having the second data transmission rate, per length of optical fiber, and

Dᵢₙₗᵢₙₑ=average under-compensation amount of the first to N-th dispersion compensation units.

Advantageously, approximately optimized pre-compensation values for the respective fiber types in the range between 0 ps/nm and −2000 ps/nm to which the invention relates are determined by these relations and bring about a significant reduction in the distortions within the optical transmission system caused by the non-linear effect of the self phase modulation and the fiber dispersion during transmission of the optical signal having a second transmission rate at least double the first transmission rate, for example optical signals having a transmission rate of 40 Gbit/s.

Advantageously all lengths of optical fiber in the optical transmission system are between 40 km and 120 km long.

Advantageous embodiments and developments of the optical transmission system to which the invention relates are disclosed in the Claims which follow.

### BRIEF DESCRIPTION OF THE DRAWINGS

The invention will be described in further detail in relation to a schematic diagram and further diagrams attached.

FIG. 1 shows the principal structure of an optical transmission system,

FIG. 2 is a diagram showing the dispersion management scheme to which the invention relates in respect of the second optical signals having a second data transmission rate,

FIG. 3 is a diagram showing the improvement in the transmission characteristics of the optical transmission system due to the pre-compensation to which the invention relates in respect of a second data transmission rate of 40 Gbit/s via a standard single mode fiber,

FIG. 4 is a diagram showing the increase in the regeneration-free, bridgeable number of lengths of optical fiber due to the pre-compensation to which the invention relates in respect of a second data transmission rate of 40 Gbit/s via a non-zero dispersion-shifted fiber,

FIG. 5 is a diagram showing the different pre-compensation amounts depending on the launch signal power and the under-compensation amount, in respect of a second data transmission rate of 40 Gbit/s via a standard single mode fiber, and

FIG. 6 is a diagram showing the different pre-compensation amounts depending on the launch signal power and the under-compensation amount, in respect of a second data transmission rate of 40 Gbit/s via a non-zero dispersion-shifted fiber.

### DETAILED DESCRIPTION OF INVENTION

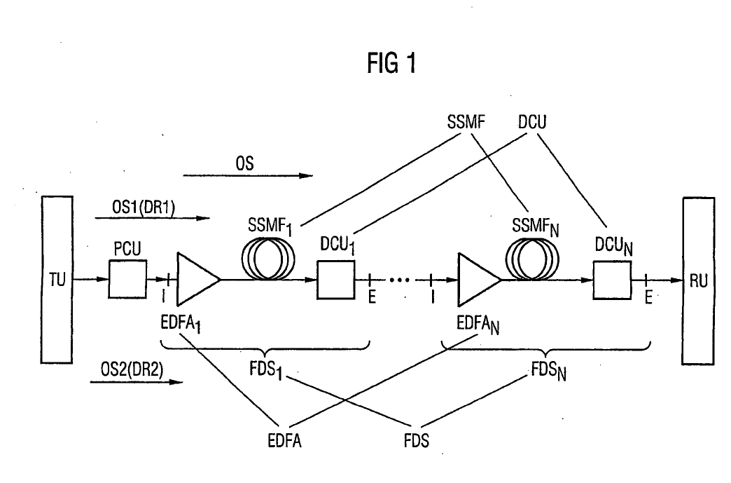

FIG. 1 shows a diagram of an optical transmission system OTS having an optical transmission unit TU and an optical reception unit RU. The optical transmission unit TU is connected to the optical reception unit RU via an optical pre-compensation unit PCU, as well as via N optical lengths of optical fiber FDS₁ to FDS_{N} each having an input I and an exit E. A length of optical fiber FDS also has in every case an optical amplifier EDFA, an optical fiber SSMF and an optical dispersion compensation unit DCU. Optical fiber SSMF means a single mode fiber which may be produced for instance in the form of a standard single mode fiber SSMF or in the form of a non-zero dispersion-shifted fiber NZDSF.

FIG. 1 shows by way of example a first and an N-th length of optical fiber FDS₁, FDS_{N}, in which a second to (N−1)-th length of optical fiber FDS₂ to FDS_{N-1} are indicated by means of a dotted line. Moreover the first length of optical fiber FDS₁ consists of a first optical amplifier EDFA, a first optical fiber SSMF₁, for instance an optical standard single mode fiber, and a first optical dispersion compensation unit DCU₁, such that still further optical amplifiers (not shown in FIG. 1) can be provided between the first optical fiber SSMF₁ and the first optical dispersion compensation unit DCU₁. Likewise the N-th length of optical fiber FDS_{N} has an N-th optical amplifier EDFA_{N}, an N-th optical fiber SSMF_{N} and an N-th optical dispersion compensation unit DCU_{N}. Likewise further optical amplifiers (not shown in FIG. 1) can be provided between the N-th optical fiber SSMF_{N} and the N-th optical dispersion compensation unit DCU_{N}. In addition the N-th dispersion compensation unit DCU_{N} is provided with the ability to compensate each of the optical signals OS1, OS2 separately.

With the aid of the pre-compensation unit PCU mounted upstream of the first length of fiber FDS₁, selected optical data signals OS are subjected to pre-compensation using different pre-compensation amounts D_{PC}.

The optical data signals OS are sent by the optical transmission unit TU to the pre-compensation unit PCU, the optical data signals OS having different data transmission rates DR1, DR2. In the embodiment shown by way of example, typically the first optical data signals OS1 are transmitted at a first optical data transmission rate DR1 and the second optical data signals OS2 are transmitted at a second optical data transmission rate DR2, the second data transmission rate DT2 being for example at least double the first optical data transmission rate DR1. With the aid of the pre-compensation unit PCU, the second optical data signals OS2 are for example subjected to pre-compensation, whereas the first optical data signals OS1 can simply be allowed through by the pre-compensation unit PCU. Alternatively the first optical data signals OS1 can be transmitted directly by the optical transmission unit TU to the input I of the first length of fiber FDS₁ or be likewise subjected to pre-compensation.

The optical signals OS delivered at the exit from the pre-compensation unit PCU are sent to the input I of the first length of optical fiber FDS₁. On this occasion the optical signals OS are multiplexed in a WDM signal. Within the first length of optical fiber FDS₁ the optical data signals OS, that is, the first and second optical data signals OS1, OS2, are amplified with the aid of the first optical amplifier EDFA₁ and transmitted via the first optical fiber SSMF₁ to the first dispersion compensation unit DCU₁. In the first dispersion compensation unit DCU₁ the signal distortions to the optical data signals OS caused by the optical transmission via the first optical fiber SSMF₁ are compensated down to a first residual dispersion Dᵢₙₗᵢₙₑ₁ which corresponds to some extent to the under-compensation amount Dᵢₙₗᵢₙₑ.

The accumulated residual dispersion Dₐₖₖ is a result of the fiber dispersion and is present at the end of the N-th length of fiber FDS_{N}. The accumulated residual dispersion Dₐₖₖ is partially uncompensated due to the eye-opening required at the end of the N-th length of fiber FDS_{N} in order to retrieve the data from the optical data signals OS. The amount of residual dispersion Dₐₖₖ needed for an optimum eye-opening is defined by the non-linear effects of the optical fiber SSMF and depends on the data transmission rates DR1, DR2, the data format and the average transmission power at the start of a length of fiber FDS. This amount can even be zero in certain cases—see DE 10127345. In some cases therefore it is advantageous to demultiplex the optical signals OS1, OS2 being transmitted, even before the N-th dispersion compensation unit FDS_{N}, and to feed the separate optical signals OS1, OS2 to the N-th dispersion compensation units DCU_{N} according to the data transfer rates DR1, DR2 used for transmission having different dispersion amounts. In other words, in order to obtain an optimum eye-opening it is advantageous for the first and second optical signals OS1, OS2 to have differently optimized residual dispersions Dₐₖₖ at the end of the optical transmission system OTS. Therefore the optical signals OS at the exit E from the N-th length of optical fiber FDS_{N} are not completely compensated in terms of dispersion, but instead have a residual dispersion that is dependent on their data transmission rates DR1, DR2.

Similarly the optical signals OS are transmitted via the further lengths of optical fiber FDS to the input I to the N-th length of optical fiber FDS_{N}. In the course of this the accumulated residual dispersion of the first optical signals OS increases in each length of fiber FDS by an amount approximately equivalent to the specified under-compensation amount Dᵢₙₗᵢₙₑ, and corresponds to the accumulated residual dispersion Dₐₖₖ after the N-th length of fiber FDS_{N}. At the end of the optical transmission system OTS, however, the accumulated residual dispersion of the second optical signals OS2 has a different accumulated residual dispersion D_{acc}.

The optical signals OS delivered at the exit E from the N-th length of optical fiber FSD_{N} are transmitted to the optical reception unit RU, if necessary before the additional processing of a 3R regeneration (not shown in FIG. 1).

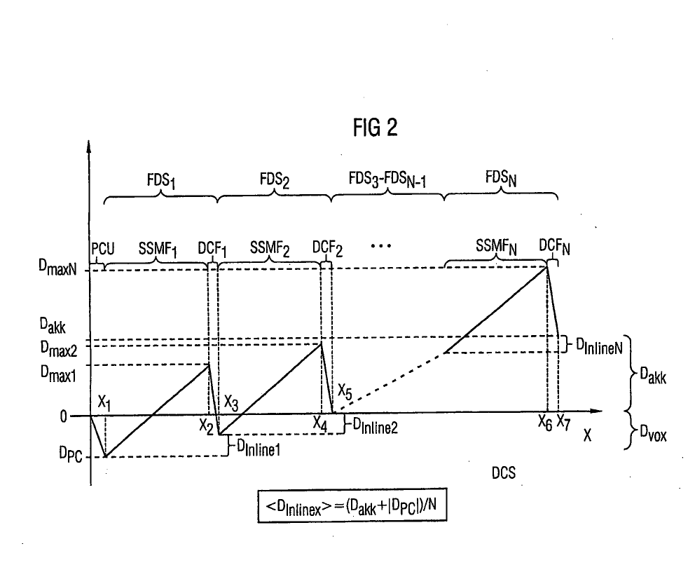

FIG. 2 is a diagram showing by way of example the dispersion management scheme DCS to which the invention relates for the second optical signals OS2. The diagram shows a first, second and N-th length of optical fiber FDS₁, FDS₂, FDS_{N}, in which the first length of optical fiber FDS₁ has a first optical fiber SSMF₁ and a first optical dispersion compensation unit DCF₁, the second length of optical fiber FDS₂ has a second optical fiber SSMF₂ and a second optical dispersion compensation unit DCF₂, and the N-th length of optical fiber FDS_{N} has an N-th optical fiber SSMF_{N} and an N-th optical dispersion compensation unit DCF_{N}. The third to (N−1)-th lengths of optical fiber FDS₃ to FDS_{N-1} are indicated by broken lines. In the embodiment shown by way of example, the lengths of the first to N-th optical fibers SSMF₁ to SSMF_{N} are approximately the same, as are those of the first to N-th dispersion compensating fibers DCF₁ to DCF_{N}. In practice, however, these can have different lengths ranging from some 40 km to 120 km. In the event of large variations in the fiber lengths FDS, the under-compensation per length of fiber FDS applied to a constant length of optical fiber SSMF can from choice be converted into a relative under-compensation amount Dᵣₑₗ_{_{—}}ᵢₙₗᵢₙₑ. Then using as the starting point an optimally accumulated residual dispersion Dₐₖₖ following the N-th length of fiber FDS_{N}, the respective under-compensation amount Dᵢₙₗᵢₙₑₓ for any length of fiber FDSᵢ is determined from the length L (FDSᵢ) of the length of fiber FDSᵢ and the total length L_{ges}=L(FDS₁)+L(FDS₂)+ . . . +L(FDS_{N}) by the following relation:
Dᵢₙₗᵢₙₑₓ=(L(FDSᵢ)*D_{acc})/L_{ges};

The diagram in FIG. 2 shows a horizontal axis x and a vertical axis D indicating on the horizontal axis x the transmission sections traveled and on the vertical axis D the amount of the fiber dispersion D in the respective lengths of optical fiber FDS.

FIG. 2 also shows that the fiber dispersion D of the second optical signals OS2 at the input to the pre-compensation unit PCU at first decreases in linear fashion and exhibits a negative pre-compensation amount D_{PC} at the exit x₁ from the pre-compensation unit PCU. The fiber dispersion D of the second optical signals OS2 increases in approximately linear fashion during transmission over the first optical fiber SSMF₁ of the first length of optical fiber FDS₁ between the input x₁ and the exit x₂ of the first optical fiber SSMF₁, and has a first maximum dispersion amount Dₘₐₓ₁ at the exit x₂. The fiber dispersion D=|D_{PC}|+Dₘₐₓ₁ caused during transmission of the second optical signals OS via the first optical fiber SSMF₁ is partially compensated with the aid of the first dispersion compensation unit DCF₁, so that the dispersion amount D at the exit x₃ of the first dispersion compensation unit DCF₁ is distinguished from the pre-compensation amount D_{PC} by the first residual dispersion Dᵢₙₗᵢₙₑ₁. Thus the first length of optical fiber FDS₁ exhibits under-compensation by the under-compensation amount Dᵢₙₗᵢₙₑ.

During transmission via the second length of optical fiber FDS₂, that is, via the second optical fiber SSMF₂, the fiber dispersion D increases in approximately linear fashion, resulting in a second maximum dispersion amount Dmax₂ at the exit x₄ of the second optical fiber SSMF₂. The second maximum dispersion amount Dmax₂ is under-compensated with the aid of the second dispersion compensation unit DCF₂ in such a way that the second residual dispersion Dᵢₙₗᵢₙₑ₂ applied to the second length of optical fiber FDS₂ again approximates to the under-compensation amount Dᵢₙₗᵢₙₑ.

The dispersion management scheme to which the invention relates in the third to (N−1)-th lengths of optical fiber FDS₃ to FDS_{N-1} is produced in a similar fashion to the above.

The optical signals OS fed into the N-th length of optical fiber DCF_{N} are transmitted via the N-tb optical fiber SSMF_{N} of the optical transmission system OTS and compensated with the aid of the N-th dispersion compensation unit DCF_{N}. FIG. 2 makes it clear that the dispersion amount D is still increasing and at the end of the N-th optical fiber x₆ exhibits an N-th maximum dispersion amount D_{maxN}. With the aid of the fourth dispersion compensation unit DCF₄ the N-th maximum dispersion amount D_{maxN} is compensated to the amount of the accumulated residual dispersion D_{acc}. The accumulated residual dispersion Dₐₖₖ illustrated affects the first optical signals OS1, which have the first data transmission rate DR1. The optimum residual dispersion Dₐₖₖ of the second optical signals OS2 can be different at this point, as described above. To obtain an optimally accumulated residual dispersion Dₐₖₖ with regard to the second optical signals OS2, a separate dispersion compensation of the second optical signals OS2 may be necessary in order to generate an optimum eye-opening at the exit E from the optical transmission system OTS (not shown in FIG. 2).

The pre-compensation of the second optical signals OS2 and the almost uniformly distributed under-compensation within the lengths of fiber FDS significantly increase the regeneration-free, bridgeable transmission range X₇ and as a result approximately the same transmission range is obtained.

The symmetrical structure of the network management scheme DCS which is illustrated in FIG. 2 also enables bi-directional data transmission over the said lengths of fiber FDS, for which purpose the pre-compensation unit PCU and possibly a separately provided post-compensation of the second optical signals OS2 are taken into consideration separately.

Furthermore a length of fiber FDS having an optical fiber SSMF and a dispersion compensation unit DCF can be configured as an optical transmission module. The optical transmission system OTS is then formed from a plurality of such optical transmission modules connected in series.

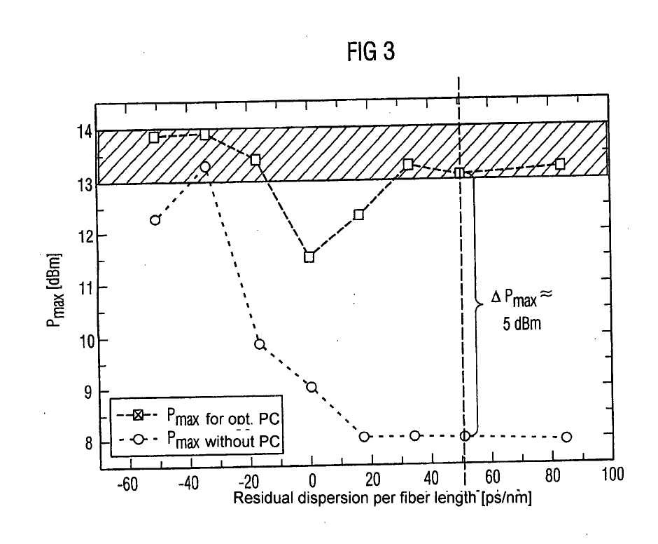

FIG. 3 is a diagram showing how the transmission quality of the optical transmission system OTS is improved by applying pre-compensation to the second optical signals OS2.

Diagram 2 indicates on the horizontal axis of the chosen under-compensation amount Dᵢₙₗᵢₙₑ and on the vertical axis the maximum power Pₘₐₓ of the transmitted second optical signals OS2. Maximum power Pₘₐₓ is the maximum power that can be launched into an optical transmission system OTS that has. only one length of optical fiber FDS in order that the transmitted optical signal OS at the end of the single length of fiber FDS exhibits so little distortion that the optical signal OS can be completely reconstructed. The number N of fiber lengths FDS that can be bridged with the aid of an optical transmission system OTS having a particular maximum power Pₘₐₓ is calculated as follows:
Pₘₐₓ=10*log(N)+P_{launch}
where

P_{launch}=launch power per length of optical fiber FDS.

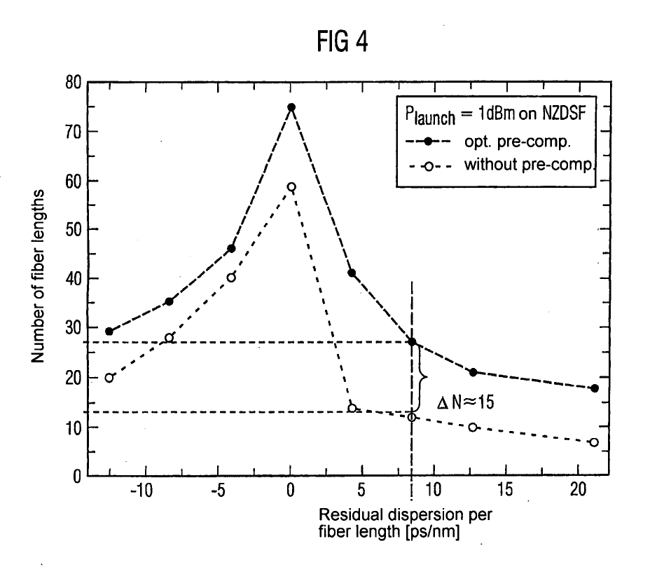

FIG. 3 and the following FIGS. 4 to 6 specify power values in dBm, a common logarithm scale referenced to 1 mW of power. The following conversion relation applies for this purpose:

Signal power [in dBm]=10*log(signal power[in mW])

Thus 1 dBm corresponds to a power of around 1.258 mW, or conversely, 1 mW is around 0 dBm.

In the embodiment envisaged in the example, second optical signals OS2 are transmitted over an optical transmission system OTS1 which is optimized in terms of dispersion for the transmission of first optical signals OS1. The optical fibers SSMF have an average fiber dispersion of 17 ps/(nm*km). In this example a length of optical fiber FDS is some 100 km long. If the under-compensation amount Dᵢₙₗᵢₙₑ per length of optical fiber FDS now amounts to say 51 ps/nm, this results in an improvement in the maximum power Pₘₐₓ of the second optical signals OS2 amounting to some 5 dBm in comparison with second optical signals OS2 transmitted without pre-compensation. This significantly increases the regeneration-free, bridgeable transmission range. By this means not only first optical signals OS1 having a first optical transmission rate of say 10 Gbit/s but also second optical signals OS2 having a second transmission rate of say 40 Gbit/s can be transmitted over more or less the maximum distance for the data transmission rate DR2.

FIG. 3 also shows the dispersion management scheme, without the pre-compensation to which the invention relates, that would have to be used in order to obtain a maximum range for the optical transmission system OTS when transmitting the second optical signals OS2. In this case a residual dispersion per fiber length amounting to some 34 ps/nin is needed in order to obtain a maximum power Pₘₐₓ of 13.1 dBm.

When transmitting second optical signals OS2 at a high bit rate over an optical transmission system OTS which is optimized in terms of dispersion for the transmission of optical signals OS1 at a lower bit rate the optical system range is reduced, which means that the disclosed transmission system is also particularly suitable for the type of application in which for example a plurality of 40-Gbit/s signals are transmitted over one or more optical transmission sub-sections of an optical transmission system OTS optimized in terms of dispersion for say 10 Gbit/s.

FIG. 4 is a further diagram showing the regeneration-free, bridgeable number N of compensated fiber lengths FDS as a function of the under-compensation amount Dᵢₙₗᵢₙₑ per fiber length FDS for optical signals OS with a launch signal power P_{launch} of 1 dBm when transmitted over a non-zero dispersion-shifted fiber NZDSF. The horizontal axis indicates the residual dispersion Dᵢₙₗᵢₙₑ per fiber length FDS of the optical transmission system OTS, and on the vertical axis the number N of optical fiber lengths FDS in the optical transmission system OTS.

The diagram shows that the pre-compensation to which the invention relates makes it possible to aim for an increase in the regeneration-free, bridgeable transmission range. The regeneration-free, bridgeable transmission range is clearly shown in FIG. 4 by the number N of compensated fiber lengths FDS in the optical transmission system OTS. For example when applying a uniform under-compensation at an under-compensation amount Dᵢₙₗᵢₙₑ of 7 ps/nm per length of fiber FDS and using the pre-compensation unit PCU to which the invention relates, the transmission range is more than doubled from 12 to 27 lengths of fiber FDS. Thus applying the same launch power P_{launch} to the second optical signals OS2 but applying the pre-compensation to which the invention relates means that the said signals can be transmitted for a further 15 lengths of fiber FDS.

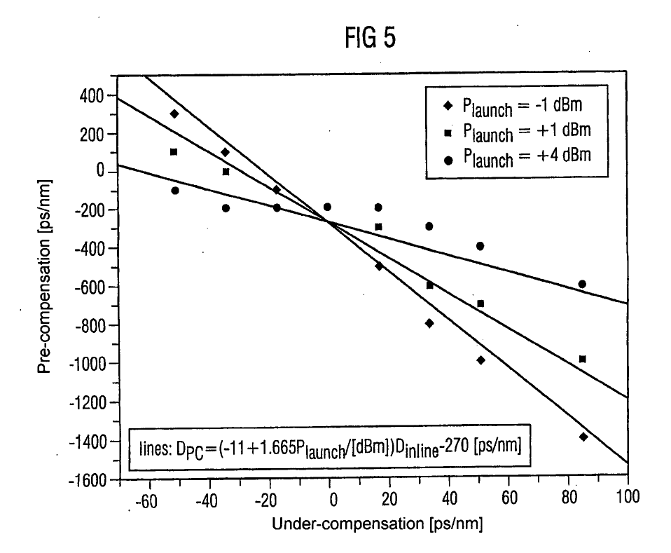

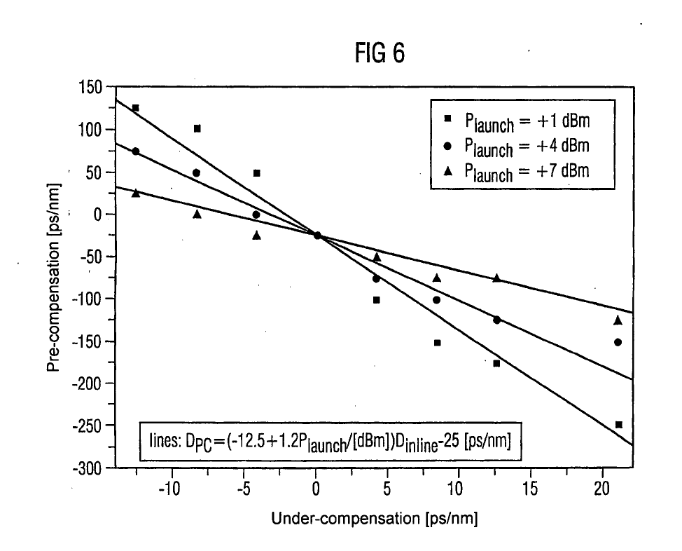

The diagrams in FIGS. 5 and 6 show the relationship between the under-compensation amount Dᵢₙₗᵢₙₑ, the launch power P_{launch} of the second optical signals OS2 and the resulting optimum pre-compensation amount D_{PC} for the standard single mode fiber SSMF (FIG. 5), and for the non-zero dispersion-shifted fiber NZDSF (FIG. 6). The diagram shows on the horizontal axis the chosen under-compensation amount Dᵢₙₗᵢₙₑ and on the vertical axis the pre-compensation amount D_{PC}. In each case three graphs for different launch powers P_{launch} are also shown by way of example. The second data transmission rate DR2 used in the embodiment envisaged in the example amounts to 40 Gbit/s using the non-return-to-zero data format.

The first graph in FIG. 5, which uses rhomboid shapes to show the measurement points, indicates the connection between the under-compensation amount Dᵢₙₗᵢₙₑ and the pre-compensation amount D_{PC} for a launch power P_{launch} of −1 dBm. The curve for a launch power P_{launch} of 1 dBm is shown by a second graph with square measurement points and the curve for a launch power P_{launch} of +4 dBm is shown by a third graph with circular measurement points. Moreover, interpolation of the measurement points results in the following mathematical relation for determining the optimum pre-compensation amount D_{PC} on the basis both of the under-compensation amount Dᵢₙₗᵢₙₑ used and of the launch power P_{launch} of the second optical signals OS2 for the standard single mode fiber:
D_{PC}=(−11+1.665·P_{launch}/[dBm])·Dᵢₙₗᵢₙₑ−270 [ps/nm]

It is an easy matter to use this relation to determine the pre-compensation amount D_{PC} for a defined under-compensation amount Dᵢₙₗᵢₙₑ and a defined launch signal power P_{launch} per length of optical fiber FDS. By this means it is possible to estimate the pre-compensation amount D_{PC} needed for transmitting a second optical signal OS2 having a second data transmission rate DR2 via an optical transmission system OTS optimized for a first data transmission rate DR1.

Similarly FIG. 6 shows the graphs for the transmission of the second optical signals OS2 over a non-zero dispersion-shifted fiber NZDSF. In the first graph the connection between the under-compensation amount Dᵢₙₗᵢₙₑ and the pre-compensation amount D_{PC} for a launch power P_{launch} of +1 dBm is shown by square measurement points. The curve for a launch power P_{launch} of +4 dBm is shown by a second graph with circular measurement points and the curve for a launch power P_{launch} of +7 dBm is shown by a third graph with triangular measurement points. Interpolation of these measurement points gives a mathematical relation for determining the optimum pre-compensation amount D_{PC} on the basis both of the under-compensation amount Dᵢₙₗᵢₙₑ used and of the launch power P_{launch} of the second optical signals OS2 for the non-zero dispersion-shifted fiber NZDSF. This relation is expressed as follows:
D_{PC}=(−12.5+1.2·P_{launch}/[dBm])·Dᵢₙₗᵢₙₑ−25[ps/nm]

By this means it is an easy matter to estimate the pre-compensation amount D_{PC} needed for the existing optical transmission system OTS and by mounting a pre-compensation unit PCU exhibiting this amount upstream, the signal distortions within the optical non-zero dispersion-shifted fiber NZDSF when transmitting second optical signals OS2 is reduced, thereby significantly increasing the regeneration-free, bridgeable transmission range.

1-10. (canceled)

11. An optical transmission system, comprising:
a first optical fiber having a first length, a first dispersion compensation unit, and a first optical signal;
a second optical fiber having a second length, a second dispersion compensation unit, and a second optical signal;
a first data transmission rate at which the first optical signal is transmitted;
a second data transmission rate at which the second optical signal is transmitted; and
a pre-compensation unit arranged upstream of the first length of optical fiber for pre-compensating the second optical signal in order to transmit the second optical signal at the second data transmission rate and the pre-compensation unit having a pre-compensating amount of between 0 ps/nm and −2000 ps/nm, wherein
the first dispersion compensation unit compensates the first optical signal as the first optical signal is sent to the second dispersion compensation unit and is dimensioned in such a way that the first optical fiber length to the second optical fiber length are respectively under-compensated by approximately the same under-compensation amount.

12. The optical transmission system according to claim 11, wherein the system is comprised of more than two optical fibers.

13. The optical transmission system according to claim 11, wherein the second data transmission rate is at least double the first data transmission rate.

14. The optical transmission system according to claim 11, wherein the pre-compensation amount is dependent on the size of the launch power of the second optical signal having a second data transmission rate, and on the type of fiber used for transmission.

15. The optical transmission system according to claims 11, wherein the first and second optical fibers are a standard single mode fiber or a non-zero dispersion-shifted fiber.

16. The optical transmission system according to claims 12, wherein the optical fibers are a standard single mode fiber or a non-zero dispersion-shifted fiber.

17. The optical transmission system according to claim 15, wherein the pre-compensation amount for a standard single mode fiber is approximated by the following relation:
D_{PC}=(−11+1.665·P_{launch}/[dBm])·Dᵢₙₗᵢₙₑ−270[ps/nm]
where
P_{launch} is the launch power of the optical signals having the second data transmission rate, per length of optical fiber, and
Dᵢₙₗᵢₙₑ is the average under-compensation amount of the first to second dispersion compensation unit.

18. The optical transmission system according to claim 15, wherein the pre-compensation amount for a non-zero dispersion-shifted fiber is approximated by the following equation:
D_{PC}=(−12.5+1.2·P_{launch}/[dBm])·Dᵢₙₗᵢₙₑ−25[ps/nm]
where
P_{launch} is the launch power of the optical signals having the second data transmission rate, per length of optical fiber, and
Dᵢₙₗᵢₙₑ is the average under-compensation amount of the first to second dispersion compensation unit.

19. The optical transmission system according to claim 15, wherein the under-compensation amount during the transmission of optical signals via a standard single mode fiber is in the range 10 to 80 ps/nm and transmission of optical signals via a non-zero dispersion-shifted fiber is in the range 5 to 60 ps/nm.

20. The optical transmission system according to claim 12, wherein the lengths of optical fiber in the optical transmission system are between 40 km and 120 km long.

21. The optical transmission system according to one of the claims 12, wherein an optical fiber and a length of optical fiber having a dispersion compensation unit form an optical transmission module, and an optical transmission system consists of a plurality of optical transmission modules arranged in series.

22. The optical transmission system according to claim 11, wherein the optical transmission system has a bidirectional operating mode.
